(19) United States
(12) Patent Application Publication
(10) Pub. No.: US 2026/0036870 A1
(43) Pub. Date: Feb. 5, 2026

(54) TERAHERTZ WAVE GENERATING DEVICE

(71) Applicant: RIKEN, Wako-shi (JP)

(72) Inventors: Hiroaki MINAMIDE, Wako-shi (JP); Yuma TAKIDA, Wako-shi (JP); Kouji NAWATA, Wako-shi (JP)

(21) Appl. No.: 19/311,779

(22) Filed: Aug. 27, 2025

(30) Foreign Application Priority Data
Jul. 3, 2024 (JP) 2024-107103

(51) Int. Cl. G02F 1/355; G02F 1/35; H01S 3/04

(52) U.S. Cl. CPC G02F 1/3558; G02F 1/3544; G02F 2203/13; H01S 3/0407

(57) ABSTRACT

A terahertz wave generating device includes: a pump light source configured to generate pump light; a periodically poled element as a nonlinear optical element having a periodic structure in which a polarization or a crystal orientation is inverted at a certain inversion period; and a rotation stage configured to rotatably support the periodically poled element. The terahertz wave generating device causes the pump light to enter the periodically poled element to generate signal light that is a terahertz wave, and rotates the periodically poled element to change a wavelength of the signal light. The periodically poled element has an incident end face through which the pump light enters and an output end face through which the pump light exits. A rotation axis of the periodically poled element is closer to the incident end face than to the output end face.

### FIELD OF THE INVENTION

The present disclosure relates to a terahertz wave generating device.

### DESCRIPTION OF THE RELATED ART

Patent Literature 1 discloses a technique for generating signal light, which is a terahertz wave, by causing pump light to enter a periodically poled element, which is a nonlinear optical element, to generate the signal light in the opposite direction to the pump light. Specifically, it is claimed that by increasing or decreasing the angle of the inversion structure in the nonlinear optical element relative to the pump light, the wavelength of the signal light, which is a terahertz wave, can be adjusted. As an example of means for increasing or decreasing the angle of the inversion structure in the nonlinear optical element relative to the pump light, there is given rotating the nonlinear optical element relative to the pump light.

### CITATION LIST

### Patent Literature

[Patent Literature 1] Japanese Patent No. 6810954

### SUMMARY OF THE INVENTION

However, when a nonlinear optical element is rotated, the pump light eventually reaches the edge of the incident end face or the edge of output end face of the nonlinear optical element, damaging the nonlinear optical element. Consequently, it has been difficult to secure a large amount of rotation angle range allowable for the nonlinear optical element.

An object of the present disclosure is to provide a terahertz wave generating device capable of rotating a nonlinear optical element by a large amount without damaging the nonlinear optical element.

There is provided a terahertz wave generating device including:
a pump light source configured to generate pump light;
a nonlinear optical element having a periodic structure in which a polarization or a crystal orientation is inverted at a certain inversion period; and
a rotation stage configured to rotatably support the nonlinear optical element,
the terahertz wave generating device causing the pump light to enter the nonlinear optical element to generate signal light that is a terahertz wave, the terahertz wave generating device rotating the nonlinear optical element to change a wavelength of the signal light,
in which the nonlinear optical element has an incident end face through which the pump light enters and an output end face through which the pump light exits, and
a rotation axis of the nonlinear optical element is closer to the incident end face than to the output end face.

According to the present disclosure, a terahertz wave generating device is provided that can rotate a nonlinear optical element by a large amount without damaging the nonlinear optical element.

### BRIEF DESCRIPTION OF THE DRAWINGS

FIG. 1 a plan sectional view of a terahertz wave generating device;

FIG. 2 is a measurement results of a transmittance spectrum of a wavelength filter;

FIG. 3 is a graph showing a relationship between the oscillation frequency of signal light and the rotation angle of a periodically poled element;

FIG. 4 is a plan view of the periodically poled element, the plan view having a dashed line indicating an optical path of pump light incident on an incident end face of the periodically poled element;

FIG. 5 is a plan view of a periodically poled element, the plan view having a dashed line indicating an optical path of pump light incident on the incident end face of the periodically poled element;

FIG. 6 is a plan view of the periodically poled element;

FIG. 7 is a graph showing changes in the wavelength of idler light due to rotation of the periodically poled element;

FIG. 8 is a plan view of a spatial resolution test apparatus; and

FIG. 9 is test results of a spatial resolution test.

### DETAILED DESCRIPTION OF THE PREFERRED EMBODIMENT

The present disclosure will be described below through embodiments of the disclosure, but the claimed disclosure is not limited to the following embodiments. Furthermore, not all of the configurations described in the embodiments are necessarily essential as means for solving the problem. For clarity of explanation, the following descriptions and drawings includes omission and simplification as appropriate. In each drawing, the same elements are denoted by the same reference numerals and characters, and duplicate descriptions are omitted as necessary.

In the following embodiments, for convenience, the description will be divided into a plurality of sections or embodiments when necessary. However, unless otherwise specified, they are not unrelated to each other, and one is a partial or complete modification, application example, detailed explanation, or supplementary explanation of the other. In addition, in the following embodiments, in a case where the number of elements (including numbers, numerical values, amounts, ranges, etc.) is mentioned, it is not limited to that specific number, and may be more or less than that specific number, unless otherwise specified or unless it is clearly limited to a specific number in principle.

Furthermore, in the following embodiments, the components (including operational steps, etc.) are not necessarily essential, unless otherwise specified or unless it is clearly considered essential in principle. Similarly, in the following embodiments, when the shape, positional relationship, or the like of components is mentioned, this includes things that are substantially similar or approximate to those shapes, etc., unless otherwise specified or unless it is clearly considered otherwise in principle. The same applies to the above numbers, etc. (including quantities, numerical values, amounts, and ranges).

In each figure, X, Y, and Z represent three mutually orthogonal spatial axes. In this specification, the directions along these axes are referred to as an X-direction, a Y-direction, and a Z-direction. In description on each figure, the direction toward arrows is referred to as the positive (+) direction, and the direction opposite the arrow is referred to as the negative (−) direction. Furthermore, in description, the directions of the three spatial axes, not limited to the positive and negative directions, are referred to as the X-axis direction, Y-axis direction, and Z-axis direction.

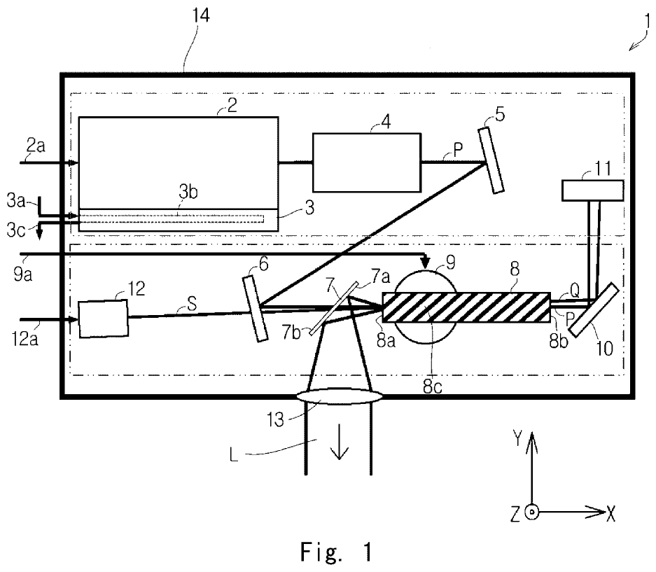

FIG. 1 shows a plan sectional view of a terahertz wave generating device 1. The terahertz wave generating device 1 is also referred to as a BW-TPO (backward terahertz-wave parametric oscillator). The terahertz wave generating device 1 includes a pump light source 2, a light source cooling plate 3, an output control unit 4, a high-reflection laser mirror 5, a wavelength filter 6, a dichroic mirror 7, a periodically poled element 8, a rotation stage 9, a high-reflection laser mirror 10, a beam damper 11, a seed collimator 12, a signal collimator 13, and a housing 14.

The pump light source 2, the light source cooling plate 3, the output control unit 4, the high-reflection laser mirror 5, the wavelength filter 6, the dichroic mirror 7, the periodically poled element 8, the rotation stage 9, the high-reflection laser mirror 10, the beam damper 11, and the seed collimator 12 are housed in the housing 14. The signal collimator 13 is provided on a side wall 14a extending in the X direction, which is the longitudinal direction of the housing 14. As shown in FIG. 1, a pump-side space 20 and a seed-side space 21 are defined that are adjacent to each other in the Y direction within the internal space of the housing 14.

In the pump-side space 20, the pump light source 2, the light source cooling plate 3, the output control unit 4, the high-reflection laser mirror 5, and the beam damper 11 are arranged in the X direction in this order. In the seed-side space 21, the seed collimator 12, the wavelength filter 6, the dichroic mirror 7, the periodically poled element 8, and the high-reflection laser mirror 10 are arranged in the X direction in this order.

The pump light source 2 generates and emits pump light P of a single wavelength. The pump light source 2 is typically an Nd: YAG laser device or a semiconductor laser device. The wavelength of the pump light P is selected from a wavelength range in which the pump light P is not absorbed by the periodically poled element 8. The wavelength of the pump light P is typically approximately 0.5 to 5 micrometers. In other words, the pump light P is laser light in the infrared or visible range. As an example, the wavelength of the pump light P is 1064 nanometers. The pump light P is typically a pulsed laser light, but may alternatively be a continuous-wave laser light. The pump light source 2 receives another pump light, typically having a wavelength of 808 nanometers, to generate the pump light P, from outside the terahertz wave generating device 1 through an optical fiber 2a.

The light source cooling plate 3 is thermally coupled to the pump light source 2 and cools the pump light source 2. The light source cooling plate 3 includes a cooling flow path 3b through which cooling water flows, the cooling water being supplied from outside the terahertz wave generating device 1 through a water supply tube 3a. The cooling water discharged from the cooling flow path 3b is discharged to the outside of the terahertz wave generating device 1 through a drainage tube 3c.

The output control unit 4 adjusts the output and beam diameter of the pump light P emitted from the pump light source 2. The output control unit 4 typically includes a half-wave plate, a polarizing beam splitter, and a lens pair. The output control unit 4 adjusts the output of the pump light P, typically to 10 megawatts.

The high-reflection laser mirror 5 reflects the pump light P, the output of which has been adjusted by the output control unit 4, and makes the pump light P incident into the wavelength filter 6.

The seed collimator 12 collimates the seed light S supplied from outside the terahertz wave generating device 1 through optical fiber 12a. As an example, the wavelength of the seed light S is 1065 nanometers or greater, typically 1065 to 1066 nanometers.

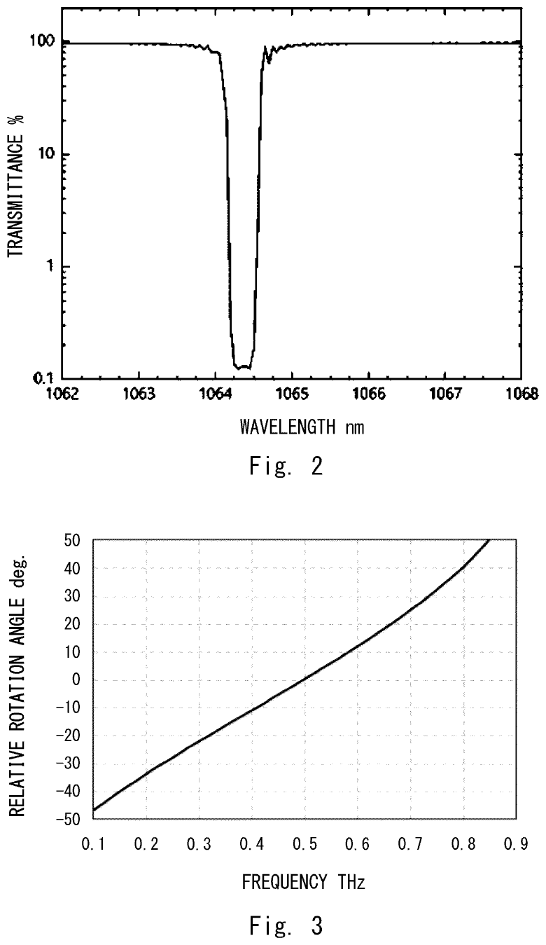

The wavelength filter 6 reflects the pump light P and transmits the seed light S. FIG. 2 shows the measurement results of the transmittance spectrum of the wavelength filter 6. In FIG. 2, the horizontal axis represents wavelength and the vertical axis represents transmittance. As shown in FIG. 2, the wavelength filter 6 is reflective to laser light having a wavelength between 1064.3 and 1064.99 nanometers and transmissive to laser light having other wavelengths. As an example, the wavelength filter 6 to be used can be a BP-1064.3-99 bandstop filter from OptiGrate (registered trademark). This wavelength filter 6 has an incident angle and a reflection angle specified when reflecting laser light. That is, the incident angle is specified as 13 to 17 degrees, and the reflection angle is specified as 13 to 17 degrees. Therefore, in this embodiment, as an example, the wavelength filter 6 is positioned so that the pump light P is incident on the wavelength filter 6 at an incident angle of 15 degrees. The pump light P reflected by the wavelength filter 6 and the seed light S transmitted through the wavelength filter 6 are transmitted through the dichroic mirror 7 and enter the periodically poled element 8.

The dichroic mirror 7 reflects terahertz waves and transmits light waves. Here, terahertz waves are electromagnetic waves with a frequency in the range of 0.1 to 100 terahertz. Typically, terahertz waves are electromagnetic waves with a frequency in the range of 0.1 to 10 terahertz. More typically, terahertz waves are electromagnetic waves with a frequency in the range of 0.1 to 1.5 terahertz. Light waves are electromagnetic waves with a wavelength of 3 micrometers to 300 nanometers. The dichroic mirror 7 includes a crystal layer and two anti-reflection coatings. Either or both of the two anti-reflection coatings can be omitted. The crystal layer is either a lithium niobate crystal layer or a lithium tantalate crystal layer. The thickness of the crystal layer is typically 10 to 50 micrometers. However, the thickness of the crystal layer is not limited thereto, and may be less than 10 micrometers or more than 50 micrometers. The crystal layer has a first surface 7a as a reflective surface on which terahertz waves are incident, and a second surface 7b opposite the first surface 7a. The lithium niobate crystal layer and the lithium tantalate crystal layer are both uniaxial crystals. The crystal compositions of the lithium niobate crystal layer and the lithium tantalate crystal layer each may be a congruent melt or a congruent composition. Two anti-reflection coatings are provided on both sides of the crystal layer. That is, two respective anti reflection coatings are provided on the first surface 7a and the second surface 7b of the crystal layer 2. The thickness of each anti reflection coating is typically 0.1 to 9 micrometers. The material of the anti-reflection coating is typically, but not limited to, magnesium fluoride or silicon dioxide. With the above configuration, the dichroic mirror 7 exhibits optical properties such as a reflectance of 50% or more for terahertz waves and a transmittance of 99% for light waves. In other words, as described above, the dichroic mirror 7 exhibits the optical properties of reflecting terahertz waves and transmitting light waves. Furthermore, even if either or both of the two anti-reflection coatings 3 are omitted, a transmittance of approximately 80 to 90% for light waves can be ensured. This is because the crystal layer has the optical property of non-absorbing to light waves and does not contain a metal layer.

The periodically poled element 8 is a specific example of a nonlinear optical element having a periodic structure in which the polarization or crystal orientation is inverted at a certain inversion period. The periodically poled element 8 of this embodiment has a periodic structure in which the polarization direction is inverted at a certain inversion period. Since nonlinear optical elements with a periodic structure due to inversion of crystal orientation also function in a manner equivalent to that of the periodically poled element 8, any subsequent description based on the periodically poled element 8 will also be considered part of the description of a periodic structure due to inversion of crystal orientation. The periodically poled element 8 is typically PPLN (periodically poled lithium niobate; LiNbO₃). The nonlinear optical element with a periodic structure due to inversion of crystal orientation is typically OP-GaAs (orientation-patterned gallium arsenide). When the pump light P with an intensity exceeding a certain threshold is incident on the periodically poled element 8, idler light Q is generated in a direction approximately parallel to the pump light P, and signal light L is generated in a direction approximately opposite to the pump light P. When the pump light P is 10 megawatts, the signal light L generated by the periodically poled element 8 is, for example, 15 watts. In addition to the pump light P being incident on the periodically poled element 8, the seed light S is incident on the periodically poled element 8 so as to satisfy the phase matching condition of the periodically poled element 8, thereby making it possible to generate idler light Q and signal light L even if the intensity of the pump light P incident on the periodically poled element 8 is low.

The periodically poled element 8 is typically a rectangular parallelepiped measuring 50 millimeters in the X direction, 5 millimeters in the Y direction, and 1 millimeter in the Z direction. The periodically poled element 8 has an incident end face 8a through which the pump light P enters and an output end face 8b from which the pump light P exits. The incident end face 8a and the output end face 8b are end faces facing each other in the X direction.

FIG. 3 shows the relationship between the oscillation frequency of the signal light L and the relative rotation angle of the periodically poled element 8, as well as the effect of refraction of the pump light P. In FIG. 3, the horizontal axis represents the oscillation frequency of the signal light L, and the vertical axis represents the relative rotation angle of the periodically poled element 8. In the graph of FIG. 3, the relative rotation angle of the periodically poled element 8 is defined so that, when the oscillation frequency of the signal light L is 0.5 terahertz, the relative rotation angle is zero. FIG. 3 shows a case where refraction of the pump light P at the incident end face 8a of the periodically poled element 8 is taken into account. In a case where the pump light P is incident on the incident end face 8a of the periodically poled element 8, the pump light P is always refracted at the incident end face 8a. FIG. 3 shows that rotating the periodically poled element 8 around the Z axis increases or decreases the oscillation frequency of the signal light L. This is because the oscillation frequency of the signal light L is determined by the intersection angle within the periodically poled element 8 between the wave vector of the pump light P and the lattice vector of the periodically poled element 8. Therefore, in order to ensure a wide tunable range of the oscillation frequency of the signal light L, it is essential to rotate the periodically poled element 8 by a large amount. Generally, when pump light P is incident from a low-refractive-index medium, such as air, to a high-refractive-index medium, such as the periodically poled element 8, the refraction angle is smaller than the incident angle.

The rotation stage 9 rotates the periodically poled element 8 around the Z axis in accordance with a drive signal supplied from outside the terahertz wave generating device 1 via a signal cable 9a. The rotation stage 9 is typically a stepping motor or servo motor. As shown in FIG. 1, the rotation axis 8c of the periodically poled element 8 to be rotated by the rotation stage 9 is set so as to be closer to the incident end face 8a than to the output end face 8b. Specifically, this is as follows.

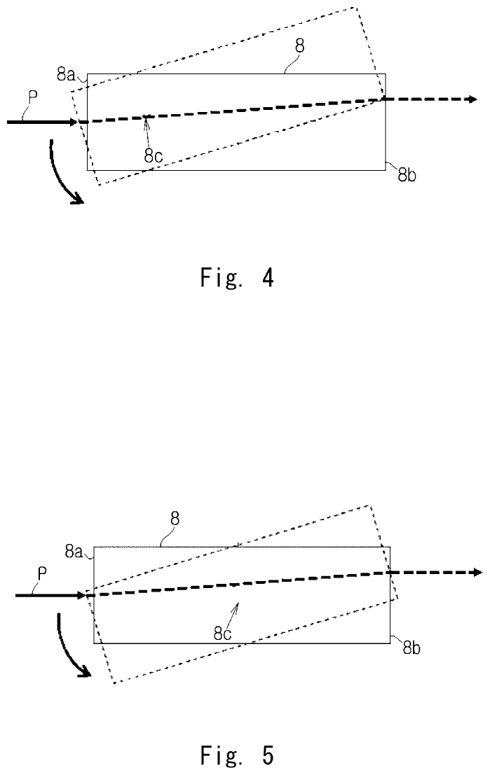

In FIGS. 4 and 5, the optical path of the pump light P incident on the incident end face 8a of the periodically poled element 8 is indicated by a dashed line. In FIG. 4, the rotation axis 8c of the periodically poled element 8 is made closer to the incident end face 8a than to the output end face 8b. In FIG. 5, the rotation axis 8c of the periodically poled element 8 is set at equal distances from the incident end face 8a and the output end face 8b. FIG. 5 shows that in a case where the rotation axis 8c of the periodically poled element 8 is set at equal distances from the incident end face 8a and the output end face 8b, even a slight rotation of the periodically poled element 8 will cause the pump light P to overlap the edge of the incident end face 8a. If the pump light P overlaps the edge of the incident end face 8a, the periodically poled element 8 will be damaged. This is because if the pump light P overlaps the edge of the incident end face 8a, the extreme electric field concentration caused by the pump light P will cause dielectric breakdown. In contrast, FIG. 4 shows that the rotation axis 8c of the periodically poled element 8 is made closer to the incident end face 8a than to the output end face 8b, and thereby the pump light P will not overlap the edge of the incident end face 8a even when the periodically poled element 8 is rotated by a large amount. From this, it can be said that the rotation axis 8c of the periodically poled element 8, which is made closer to the incident end face 8a than to the output end face 8b, can ensure a large rotation angle range for the periodically poled element 8.

Continuing to refer to FIG. 4, if the rotation axis 8c of the periodically poled element 8 is made closer to the incident end face 8a than to the output end face 8b, there is a risk that the pump light P will overlap the edge of the output end face 8b. If the pump light P overlaps the edge of the output end face 8b, the periodically poled element 8 will be damaged. The reason for this is as described above. Therefore, the rotation axis 8c of the periodically poled element 8 cannot be set close to the incident end face 8a indiscriminately.

Then, in order to maximize the rotation angle range of the periodically poled element 8 without damaging the periodically poled element 8 with the pump light P emitted to the incident end face 8a of the periodically poled element 8, the rotation axis 8c of the periodically poled element 8 is set as follows.

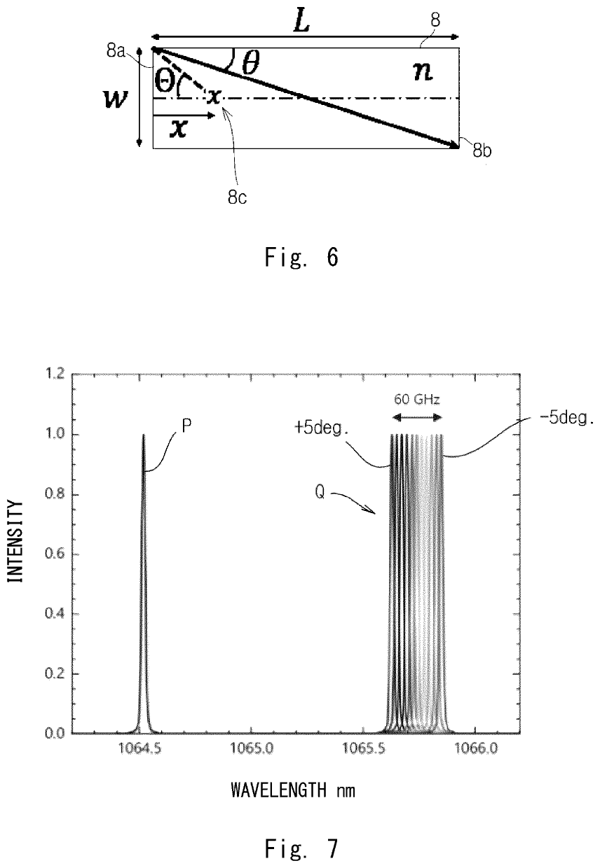

FIG. 6 is a plan view of the periodically poled element 8 as viewed in the Z direction. In FIG. 6, a variable Θ is the incident angle of the pump light P incident on the incident end face 8a of the periodically poled element 8. A variable θ is the refraction angle of the pump light P inside the periodically poled element 8. A variable x is the rotation axis distance that is a distance from the incident end face 8a to the rotation axis 8c of the periodically poled element 8 in the longitudinal direction of the periodically poled element 8. A variable L is the element length in the rotation plane of the periodically poled element 8. A variable w is the element width in the rotation plane of the periodically poled element 8. A variable n is the refractive index of the periodically poled element 8. In FIG. 6, when the rotation axis distance x satisfies the following expression, the rotation angle range of the periodically poled element 8 is maximized without damaging the periodically poled element 8. The derivation of the following expression is explained below:

$$x = \frac{\sqrt{{L}^{2} + {w}^{2} ( 1 - {n}^{2} )}}{2 n}$$

Because the element width w on the rotation plane of the periodically poled element 8 is finite, the upper limit of the rotation angle of the periodically poled element 8 (=the incident angle Θ of the pump light P) is determined by either or both of the following (1) and (2).
(1) When the periodically poled element 8 is rotated by Θ, the pump light P incident on the incident end face 8a reaches the edge of the incident end face 8a.
(2) When the periodically poled element 8 is rotated by Θ, the pump light P incident on the output end face 8b reaches the edge of the output end face 8b.

If only the condition (1) above is satisfied but the condition (2) above is not satisfied, this means that the rotation axis 8c of the periodically poled element 8 is too far from the incident end face 8a, as shown in FIG. 5. Contrarily, if only the condition (2) above is satisfied but the condition (1) above is not satisfied, this means that the rotation axis 8c of the periodically poled element 8 is too close to the incident end face 8a, as shown in FIG. 4. Therefore, in a case where the conditions (1) and (2) above are satisfied simultaneously, the rotation angle range of the periodically poled element 8 can be maximized.

The condition for simultaneously satisfying conditions (1) and (2) above can be geometrically expressed by the following expression.

$$\begin{matrix}\frac{w}{L} = tan θ \\ \frac{\frac{w}{2}}{x} = tan Θ\end{matrix}$$

Furthermore, considering the refraction of the pump light P at the incident end face 8a of the periodically poled element 8, the following Snell's law holds true.

$$n sin θ = sin Θ$$

Summarizing the above expressions, an expression described above is obtained that maximizes the rotation angle range of the periodically poled element 8 without damaging the periodically poled element 8.

Here, assuming the wavelength of the pump light P is 1064 nanometers and the refractive index of the periodically poled element 8 is 2.15, for example, if the element length L is 50 millimeters and the element width w is 5 millimeters, the rotation axis distance x is 11.4 millimeters. Also, for example, if the element length L is 40 millimeters and the element width w is 5 millimeters, the rotation axis distance x is 9.0 millimeters. Also, for example, if the element length L is 50 millimeters and the element width w is 10 millimeters, the rotation axis distance x is 10.7 millimeters. However, if the following expression is satisfied, the rotation axis distance x is 0 millimeters.

$$L < w \sqrt{{n}^{2} - 1}$$

FIG. 7 is a graph showing the change in the wavelength of the idler light Q due to rotation of the periodically poled element 8. In FIG. 7, the horizontal axis represents wavelength, and the vertical axis represents normalized intensity. FIG. 7 shows the frequency characteristics of the intensity of the idler light Q when the rotation angle of the periodically poled element 8 is +5 degrees, +4 degrees, +3 degrees, +2 degrees, +1 degree, zero degrees, −1 degree, −2 degrees, −3 degrees, −4 degrees, and −5 degrees. FIG. 7 demonstrates that optimizing the rotation axis distance x as described above makes it possible, for example, to secure 10 degrees of a rotation angle range of the periodically poled element 8, thereby freely increasing or decreasing the wavelength of the idler light Q between 1065.63 and 1065.85 nanometers. The wavelength of the terahertz waves generated by the periodically poled element 8 corresponds to the difference between the wavelength of the pump light P and the wavelength of the idler light Q. Therefore, in the example of FIG. 7, it can be said that the frequency of the signal light L that is the terahertz waves can be tuned for approximately 60 gigahertz between 0.29 and 0.35 terahertz.

Returning to FIG. 1, the high-reflection laser mirror 10 reflects the pump light P and idler light Q emitted from the output end face 8b of the periodically poled element 8, to cause them to enter the beam damper 11. As a result, the pump light P and idler light Q emitted from the output end face 8b of the periodically poled element 8 are blocked by the beam damper 11. In this way, the pump light P and idler light Q emitted from the output end face 8b of the periodically poled element 8 are reflected at approximately a right angle by the high-reflection laser mirror 10 before being incident on the beam damper 11. This secures a long optical path from the output end face 8b to the beam damper 11, preventing the 0.1 megawatt-class pump light P, reflected by approximately 1% by the concave lens of the beam damper 11, from being focused within the periodically poled element 8 and damaging the periodically poled element 8.

The signal light L generated by the periodically poled element 8 is emitted in the minus X direction from the incident end face 8a of the periodically poled element 8, reflected by the dichroic mirror 7, and collimated by the signal collimator 13. After emitted from the incident end face 8a of the periodically poled element 8, the signal light L diverges, so that its beam diameter expands. Therefore, in order to capture all of the signal light L whose beam diameter is expanding and reflect it toward the signal collimator 13, the dichroic mirror 7 is positioned as close as possible to the incident end face 8a of the periodically poled element 8. If the dichroic mirror 7 were positioned between the wavelength filter 6 and the seed collimator 12, the dichroic mirror 7 would only be able to capture a part of the signal light L whose beam diameter expands. In the first place, in a case where the signal light L is extracted from the terahertz wave generating device 1 after passing through the wavelength filter 6, the signal light Lis attenuated by the wavelength filter 6, so that high-power signal light L cannot be obtained. In this sense as well, it is preferable to position the dichroic mirror 7 between the wavelength filter 6 and the periodically poled element 8.

Referring again to FIG. 1, the pump light P and the seed light S need to be incident on the periodically poled element 8 at a slight angle to each other to satisfy the phase matching condition of the periodically poled element 8. Here, if the wavelength filter 6 were not used, both the pump light source 2 and the seed collimator 12 have to be positioned in the seed-side space 21. Then, to prevent the pump light source 2 from interfering with the optical path of the seed light S and to prevent the seed collimator 12 from interfering with the optical path of the pump light P, the pump light source 2 and the seed collimator 12, positioned in the seed-side space 21, would need to be positioned far away from the periodically poled element 8. In contrast, with the configuration in which the wavelength filter 6 is used to reflect the pump light P to approximately align the optical paths of the pump light P and seed light S, the pump light source 2 can be positioned in the pump-side space 20 rather than the seed-side space 21, significantly reducing the longitudinal size of the terahertz wave generating device 1. Note that while the wavelength filter 6 is generally used as a beam splitter, in this embodiment the wavelength filter 6 is used as a beam combiner that gets together the pump light P and the seed light S. Using the wavelength filter 6 as a beam combiner rather than a beam splitter in this manner is considered to be a design concept unique to this embodiment.

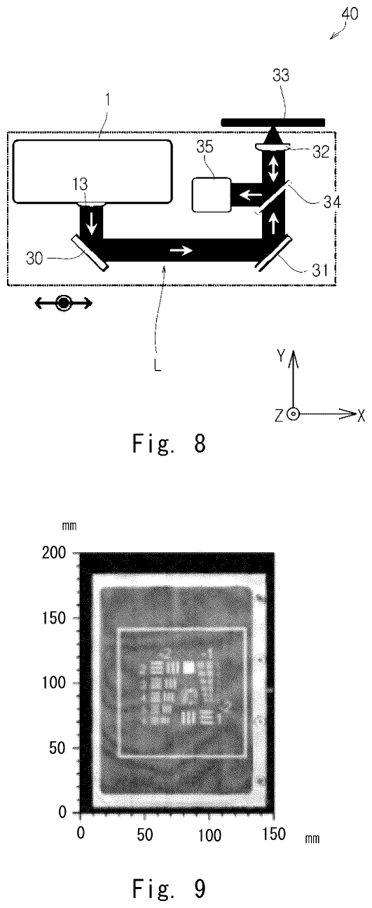

Finally, with reference to FIGS. 8 and 9, a spatial resolution test of the signal light L, which is generated by the terahertz wave generating device 1, will be introduced.

FIG. 8 is a plan view of the test apparatus 40. In FIG. 8, the terahertz wave generating device 1 is mounted on a motorized stage that moves the terahertz wave generating device 1 in the X and Z directions. Signal light L emitted from the signal collimator 13 of the terahertz wave generating device 1 is reflected by the first mirror 30 and the second mirror 31 and focused onto the resolution test chart 33 by a Tsurupica lens 32 (registered trademark). USAF1951 was used for the resolution test chart 33. The signal light L reflected by the resolution test chart 33 was collimated again by the Tsurupica lens 32 and detected by a Schottky barrier diode detector 35 using a beam splitter 34. In the spatial resolution test, a raster scan was performed in which the terahertz wave generating device 1 was moved 1 millimeter at a time in the X and Z directions. FIG. 9 shows the test results using signal light L with a frequency of 0.33 terahertz. The units of the horizontal and vertical axes in FIG. 9 are both millimeters. FIG. 9 indicates that the spatial resolution of the terahertz wave generating device 1 is 2 millimeters or less. Furthermore, the signal light L is always stable during raster scanning, thereby demonstrating that the robustness of the terahertz wave generating device 1 as a sensing technology has reached a practical level.

The above has described a preferred embodiment of the present disclosure. The above embodiment has the following features. That is, the terahertz wave generating device 1 includes a pump light source 2 that generates pump light P, a periodically poled element 8 as a nonlinear optical element having a periodic structure in which the polarization or crystal orientation is inverted at a certain inversion period, and a rotation stage 9 that rotatably supports the periodically poled element 8. The pump light P is incident on the periodically poled element 8 to generate signal light L, which is a terahertz wave, and the periodically poled element 8 is rotated to change the wavelength of the signal light L. The periodically poled element 8 has an incident end face 8a through which the pump light P enters, and an output end face 8b from which the pump light P exits. The rotation axis 8c of the periodically poled element 8 is closer to the incident end face 8a than to the output end face 8b. The above configuration provides a terahertz wave generating device that can rotate the periodically poled element 8 by a large amount without damaging the periodically poled element 8.

Furthermore, the rotation axis distance x, which is the distance between the incident end face 8a and the rotation axis 8c of the periodically poled element 8, is set so that, when the pump light P enters from the edge of the incident end face 8a, the pump light P exits from the edge of the output end face 8b. With the above configuration, the rotation angle range of the periodically poled element 8 can be maximized without damaging the periodically poled element 8.

The terahertz wave generating device 1 further includes a wavelength filter 6 that transmits the seed light S supplied from the outside and reflects the pump light P. The seed light S is transmitted through the wavelength filter 6 and is then incident on the incident end face 8a of the periodically poled element 8. The pump light P is reflected by the wavelength filter 6 and is then incident on the incident end face 8a of the periodically poled element 8. With the above configuration, the pump light source 2 can be positioned away from the optical path of the seed light S, thereby achieving a more compact size in the longitudinal direction of the terahertz wave generating device 1.

The terahertz wave generating device 1 further includes a dichroic mirror 7 that is provided between the periodically poled element 8 and the wavelength filter 6 and transmits the pump light P and the seed light S and reflects the signal light L generated by the periodically poled element 8. With the above configuration, the signal light L generated by the periodically poled element 8 can be extracted from the terahertz wave generating device 1 without attenuation and without omission.

Furthermore, the pump light source 2 is water-cooled. With the above configuration, the cooling performance of the pump light source 2 can be ensured with a small dedicated area, contributing to the downsizing of the terahertz wave generating device 1.

This application claims priority based on Japanese Patent Application No. 2024-107103, filed Jul. 3, 2024, the disclosure of which is incorporated herein in its entirety.

### INDUSTRIAL APPLICABILITY

A terahertz wave generating device can be provided that can rotate a nonlinear optical element by a large amount without damaging the nonlinear optical element.

### REFERENCE SIGNS LIST

1 TERAHERTZ WAVE GENERATING DEVICE
2 PUMP LIGHT SOURCE
2a OPTICAL FIBER
3 LIGHT SOURCE COOLING PLATE
3a WATER SUPPLY TUBE
3b COOLING FLOW PATH
3c DRAINAGE TUBE
4 OUTPUT CONTROL UNIT
5 HIGH-REFLECTION LASER MIRROR
6 WAVELENGTH FILTER
7 DICHROIC MIRROR
7a FIRST SURFACE
7b SECOND SURFACE
8 PERIODICALLY POLED ELEMENT
8a INCIDENT END FACE
8b OUTPUT END FACE
8c ROTATION AXIS
9 ROTATION STAGE
9a SIGNAL CABLE
10 HIGH-REFLECTION LASER MIRROR
11 BEAM DAMPER
12 SEED COLLIMATOR
12a OPTICAL FIBER
13 SIGNAL COLLIMATOR
14 HOUSING
14a SIDE WALL
20 PUMP-SIDE SPACE
21 SEED-SIDE SPACE
30 FIRST MIRROR
31 SECOND MIRROR
33 RESOLUTION TEST CHART
34 BEAM SPLITTER
35 SCHOTTKY BARRIER DIODE DETECTOR
40 TEST APPARATUS
P PUMP LIGHT
S SEED LIGHT
Q IDLER LIGHT
L SIGNAL LIGHT
x ROTATION AXIS DISTANCE
w ELEMENT WIDTH
θ INCIDENT ANGLE

1. A terahertz wave generating device, comprising:
a pump light source configured to generate pump light;
a nonlinear optical element having a periodic structure in which a polarization or a crystal orientation is inverted at a predetermined inversion period; and
a rotation stage configured to rotatably support the nonlinear optical element,
wherein the pump light is incident on the nonlinear optical element to generate signal light that is a terahertz wave and rotation of the nonlinear optical element changes a wavelength of the signal light,
the nonlinear optical element has an incident end face through which the pump light enters and an output end face through which the pump light exits, and
a rotation axis of the nonlinear optical element is closer to the incident end face than to the output end face.

2. The terahertz wave generating device according to claim 1, wherein a rotation-axis distance, which is a distance between the incident end face and the rotation axis of the nonlinear optical element, is set such that, when pump light is incident on an edge of the incident end face, the pump light exits from an edge of the output end face.

3. The terahertz wave generating device according to claim 2, wherein the rotation axis distance is set in accordance with the following expression,
$$x = \frac{\sqrt{{L}^{2} + {w}^{Z} ( 1 - {n}^{2} )}}{2 n}$$
where x is the rotation-axis distance, L is a length of the nonlinear optical element in a rotation plane, w is a width of the nonlinear optical element in the rotation plane, and n is a refractive index of the nonlinear optical element.

4. The terahertz wave generating device according to claim 1, further comprising a wavelength filter that transmits seed light supplied from outside and reflects the pump light,
wherein the seed light, after being transmitted through the wavelength filter, is incident on the incident end face of the nonlinear optical element, and wherein the pump light, after being reflected by the wavelength filter, is incident on the incident end face of the nonlinear optical element.

5. The terahertz wave generating device according to claim 4, further comprising a dichroic mirror that is disposed between the nonlinear optical element and the wavelength filter, and transmits the pump light and the seed light, and reflects the signal light generated by the nonlinear optical element.

6. The terahertz wave generating device according to claim 1, wherein the pump light source is water-cooled.
